(19) United States
(12) Patent Application Publication
(10) Pub. No.: US 2012/0298824 A1
(43) Pub. Date: Nov. 29, 2012

(54) SYSTEMS AND METHODS FOR REMOVABLY CONNECTING TEXTILES TO A SUPPORT MEMBER

(76) Inventors: Randall D. West, Provo, UT (US); Laurel Michelle West, Provo, UT (US)

(21) Appl. No.: 13/478,987

(22) Filed: May 23, 2012

Related U.S. Application Data
(60) Provisional application No. 61/489,531, filed on May 24, 2011.

(51) Int. Cl. F16B 2/20

(52) U.S. Cl. 248/316.7

(57) ABSTRACT

A method for hanging and retrieving a textile object from a support member includes spreading open a resilient gripping member and placing the resilient gripping member around the support member such that the textile object hangs from the support member. Pulling on the textile object releases the textile object from the support member,

### RELATED DOCUMENTS

The present application claims priority under 35 U.S.C. §119(e) to U.S. Provisional Application No. 61/489,531, by Randall West et al., filed on May 24, 2011, and entitled “Secure Grip for Hanging a Small Towel,” which application is hereby incorporated by reference in its entirety.

### BACKGROUND

Storage and retrieval of objects can often be conveniently accomplished by attaching the object to a support member and allowing the objects to hang down from the support member under the influence of gravity. However, engaging and disengaging the object from the support member can be inconvenient and require both attention and focused dexterity to accomplish. For example, a towel may be hung over a hook for storage. To hang the towel on the hook, a relatively precise amount of the towel must be placed over the hook to engage the towel with the hook. If not enough of the towel is engaged with the hook, the weight of the towel will pull the small amount of fabric off the hook and allow the towel to fall to the ground. If a user attempts to engage too much of the towel into the hook, the bulk of the fabric cannot be forced into the hook and the towel falls on the floor. Even if the towel successfully hangs from the hook, particular attention on the removal of the towel from the hook is required. For example, removal of the towel from the hook cannot typically be accomplished by simply jerking downward on the towel. This downward motion simply engages the towel more firmly in the hook and/or damages the hook. Similarly, attempting to remove the towel from the side can be ineffective and result in damage to the hook. In most cases, to successfully remove the towel from the hook, the towel must be lifted upward off the hook. This motion is often inconvenient from the position or location of the user.

Similar problems occur when textiles, such as a towel, are engaged with a rod, To hang a towel from a rod, one side of the towel is threaded over the rod until an approximately equal amount of the towel is hanging from both sides of the rod. Often this is a two handed operation, with an upper hand grasping the edge of the towel and threading it over the rod, and a second hand reaching under the rod to grip the towel and pull it over the rod. The correct amount of towel must hang from each side of the rod for the towel to remain in place. If too much of the towel hangs on any one side, the towel will fall on the ground, Removal of the towel from the rod can be difficult, particularly when the bulk of the towel jams between the rod and the surface supporting the rod, preventing its removal.

A variety of other systems and methods for hanging flexible textiles and fabrics have been proposed and used. In some implementations, clips may be used to connect the textiles to a support member, However, clips require two hands to be used, one to open the clip and the other hand to force the towel into the clip. In other implementations, a textile such as a towel may include a flap that buttons around a rod. In this case, the towel becomes semi-permanently connected to the support member. To remove the towel, both hands and a significant amount of attention must be used to unbutton the flap and remove the towel. This type of connection is often used for kitchen towels hung from an oven door handle. In addition to being inconvenient, this type of connection can be unsafe. For example, if a small child grabs the towel and pulls on it, the oven door may open, exposing the hot interior. Additionally, if a user working in the kitchen has the misfortune of becoming tangled in the towel, the towel does not simply slide off the oven door handle. Instead, because the towel is secured to the oven handle, the entangled user may be jerked or tripped by the towel.

Thus, current methods for attaching flexible textiles, fabrics or other similar objects to support members can be both inconvenient and ineffective in allowing the textile to be securely connected to a support member while still remaining easily removable from a wide range of angles.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a textile assembly hanging from a support member, according to one example of principles described herein.

FIG. 2 is a side view illustrating the textile assembly hanging from a support member, according to one example of principles described herein.

FIG. 3 depicts a resilient member fastened to a top portion of the textile, according to one example of principles described herein.

FIG. 4 depicts a resilient gripping member fastened on a corner of the textile, according to one example of principles described herein.

FIG. 5 depicts a resilient gripping member fastened to a face of the textile, according to one example of principles described herein.

FIG. 6 illustrates a method for attaching the textile assembly to a support member, according to one example of principles described herein.

FIG. 7 illustrates an alternative method for attaching the textile assembly to a support member, according to one example of principles described herein.

FIGS. 8A and 8B show possible pocket or sleeve configurations and methods for securing a resilient gripping member with the pocket or sleeve, according to one example of principles described herein.

FIG. 9 is a diagram of an illustrative resilient gripping member with an integral fastener at one end, according to one example of principles described herein.

FIG. 10 is a flowchart illustrating a method for using a resilient gripping member to attach a textile to a support member, according to one example of principles described herein.

FIG. 11 is a diagram of a textile assembly connected to the handle of a baby carrier, according to one example of principles described herein.

FIG. 12 is a diagram of a textile assembly used as a nursing cover, according to one example of principles described herein.

FIGS. 13A and 13B show an illustrative method for storing the textile assembly, according to one example of principles described herein.

Throughout the drawings, identical reference numbers designate similar, but not necessarily identical, elements.

### DETAILED DESCRIPTION

The principles described below allow a textile to be securely connected to a support member while still allowing the textile to be removed from a variety of angles and without danger that the textile will snag on the support member during removal. In general, one or more resilient gripping members are connected to the textile. The resilient gripping member grips the support member and secures the textile in place. To remove the textile from the support member, the user simply pulls on the textile from any direction and the resilient gripping member opens to release the support member. In some examples, the resilient gripping member is bi-stable, with a stable open position and a stable closed position.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

The principles below describe a resilient gripping member for hanging a textile from a support member. The resilient gripping member secures the textile to the support member to prevent the textile from falling off. This resilient gripping member can have a variety of configurations, including a resilient spring, such as a bi-stable ribbon spring, that is attached to the textile. The resilient gripping member closes around the support member to secure the textile in place. When the textile is to be removed, the textile is pulled and the resilient gripping member opens to release the textile from the support member. When not in use, the resilient gripping member can be wrapped around the textile to keep the textile securely folded and presentable. Figure (Insert figure number for new drawing) shows the folded position of the textile assembly. In this example, the textile has been rolled up from the side opposite the resilient gripping member as shown in Figure (#). The resilient member is closed around the rolled towel to secure it in place.

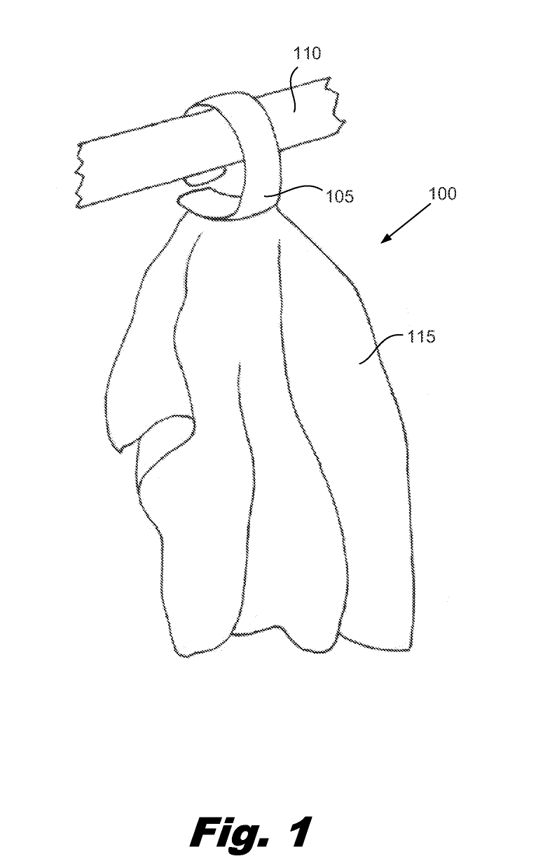

FIG. 1 shows a textile assembly (100) that includes a textile portion (115) secured to a support member (110) by a resilient gripping member (105). The textile may be any of a wide variety of objects and may be formed from a range of materials. For example, the textile may be a towel, a bag, a curtain, or an article of clothing. The textile may be formed from natural or synthetic materials and may be a fabric, mesh, or film. In the illustrative example shown in FIG. 1, the textile (115) is illustrated as a hand towel. In figure #, the textile is illustrated as a child's car seat cover or curtain. This example includes two resilient gripping members secured around the car seat handle. In figure #, the textile is illustrated as a breastfeeding curtain worn over the woman's chest for privacy. This example includes two resilient gripping members secured to the arms of the woman breastfeeding her child so that the textile covers the chest.

In one embodiment, the resilient gripping member (105) has an open and closed state. For example, the resilient gripping member (105) may be a bi-stable ribbon spring. Bi-stable ribbon springs are formed from a variety of materials, such as metals and plastics. Bi-stable ribbon springs have two stable states: a first state where the ribbon spring is straight along its length and curved along its width and a second state where the ribbon spring is curved along its length and straight across its width. Other types of resilient gripping members (105) that exhibit an open state and a closed state could also be used, These other types of resilient gripping members may be stable in one or more open or closed states.

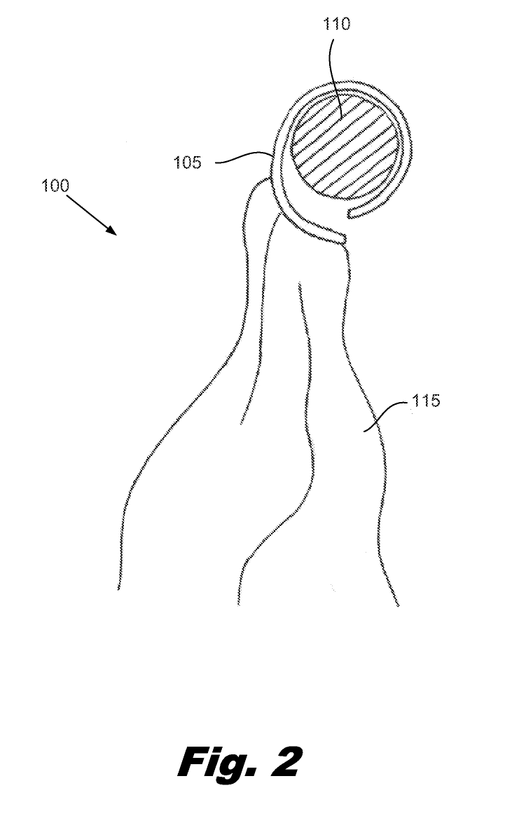

FIG. 2 is a side view of the textile assembly (100) with the resilient gripping member (105) wrapped around a support member (110). In this configuration, the resilient gripping member (105) is in its curved or dosed state and completely or partially surrounds the support member.

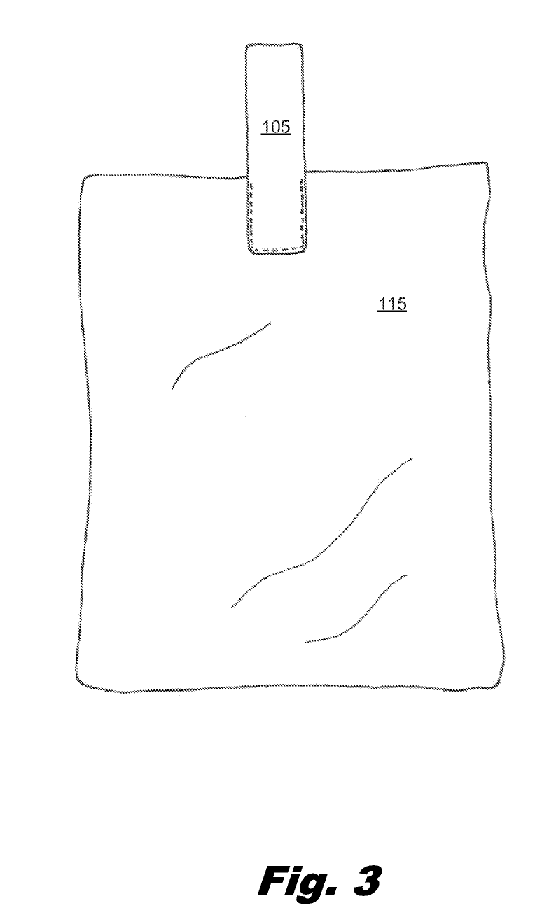

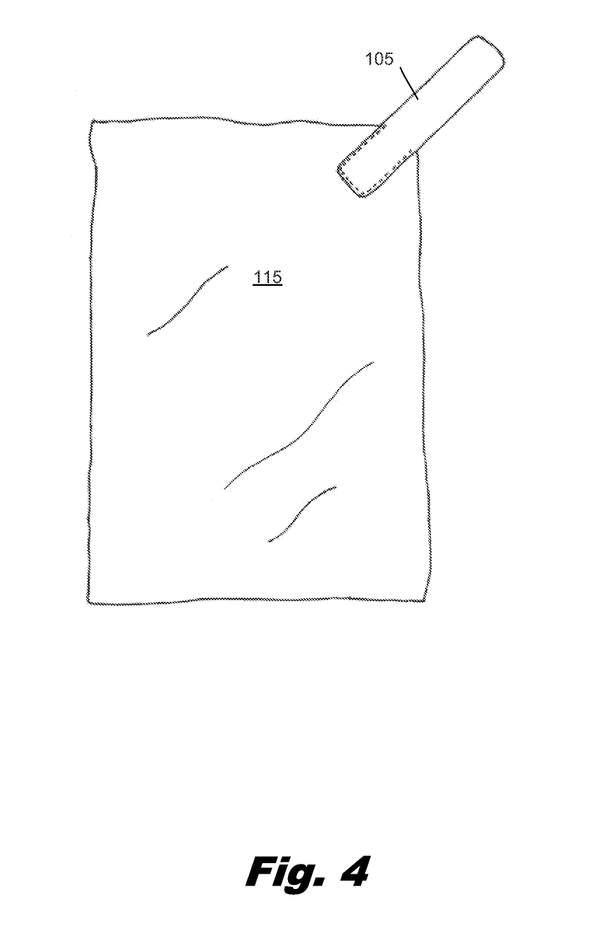

The resilient gripping member (105) can be connected to the textile (115) in a variety of locations. The location of the resilient gripping member (105) may be selected according to the particular design and usage of the textile. FIG. 3 shows the resilient gripping member (105) attached to top center of a textile (115). FIG. 4 shows the resilient gripping member (105) attached to one corner of the textile (115). For example, if the textile is a bag used for storage, the edge positions shown in FIGS. 3 and 4 show may used to allow access to the interior of the bag without removal of the bag from the support member (110, FIG. 1).

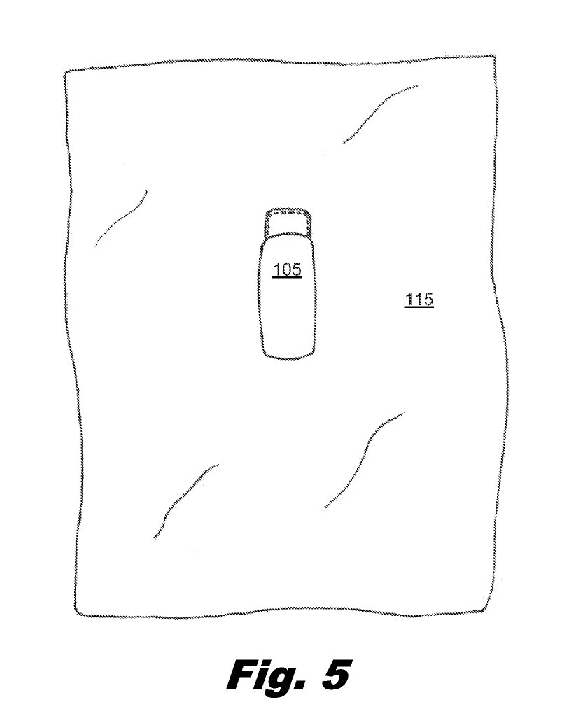

FIG. 5 shows the resilient gripping member (105) attached to an interior portion of the textile (115). This position may be advantageous in preventing the textile (115) from undesirably dangling long distances from the support member (110, FIG. 1) and holding the textile (115) in a convenient configuration for use. For example, if the textile is a golf towel, it may be desirable for the resilient gripping member to be attached near the center of the towel. The resilient gripping member can then be used to connect the golf towel to a golf bag. The golf towel hangs down on all sides of the centrally located resilient gripping member. To clean a club after use, the head of the club is inserted upward into the underside of the towel. The user can support the club inside the towel using one hand and the other hand can manipulate the outside of the towel to clean the club.

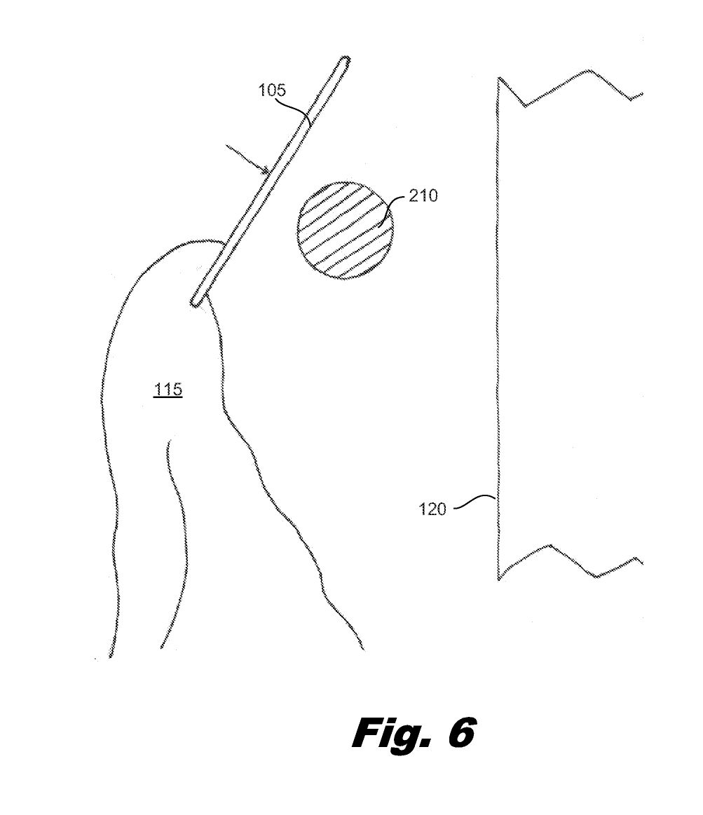

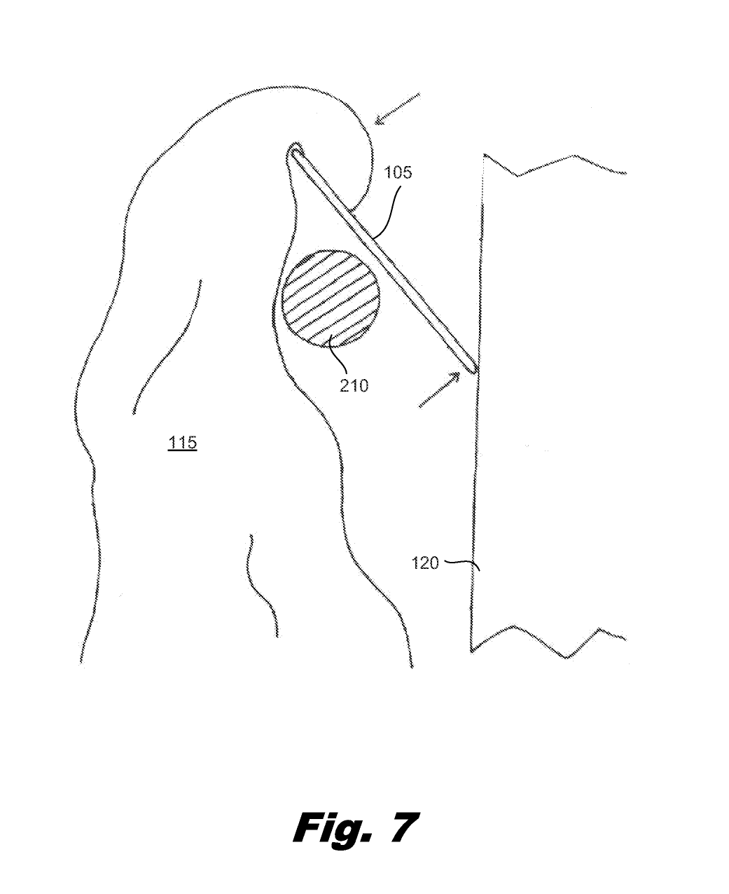

FIGS. 6 and 7 show several methods for attaching the resilient gripping member to a support member. The support member may have an open or closed configuration. For example, a hook or peg has an open configuration and a rod supported by both ends has a closed configuration. In these examples, the resilient gripping member (105) is a bi-stable spring and the support member is a horizontal rod (210) that is supported (typically from near the ends) by a surface (120). Initially, the bi-stable ribbon spring is in its straight configuration. In the connection method shown in FIG. 6, the bi-stable spring of the resilient gripping member (105) is in its straight configuration. The resilient gripping member (105) is tapped against the horizontal rod (210) as shown by the arrow, This straightens the curve across the width of the bi-stable spring and the bi-stable spring spontaneously converts to its second stable position where the spring is curved along its length and straight across its width. This curls the bi-stable spring around the horizontal rod (210). The textile (115) is then secured to the horizontal rod. This connecting operation is a one handed action that conveniently attaches the towel to the support member from a wide range of angles. Because the bi-stable spring automatically curls around the horizontal rod (210) as it transitions to its curved position, there is no need for the user stop and use both hands to thread the textile (115) around the horizontal rod (210).

FIG. 7 shows an alternative method for attaching the resilient gripping member to a support member. In this example, the user inserts the bi-stable spring of the resilient gripping member (105) in its straight configuration into the space between the support surface (120) and the horizontal rod (210) supported by the support surface (120). The tip of the bi-stable spring contacts the support surface (120) and the base of the bi-stable spring, which is connected to the textile (115), is moved outward and downward, as shown by the arrows, so that the center of the bi-stable spring will press against the horizontal rod (210), This initiates the transition of the bi-stable spring from its straight configuration to its curled configuration around the horizontal rod (210).

Although the support member shown in the previous figures is described as a horizontal rod, such as the handle to an oven door, the support member could be a vertical rod, such as a refrigerator door or a hook, a peg, or other support member.

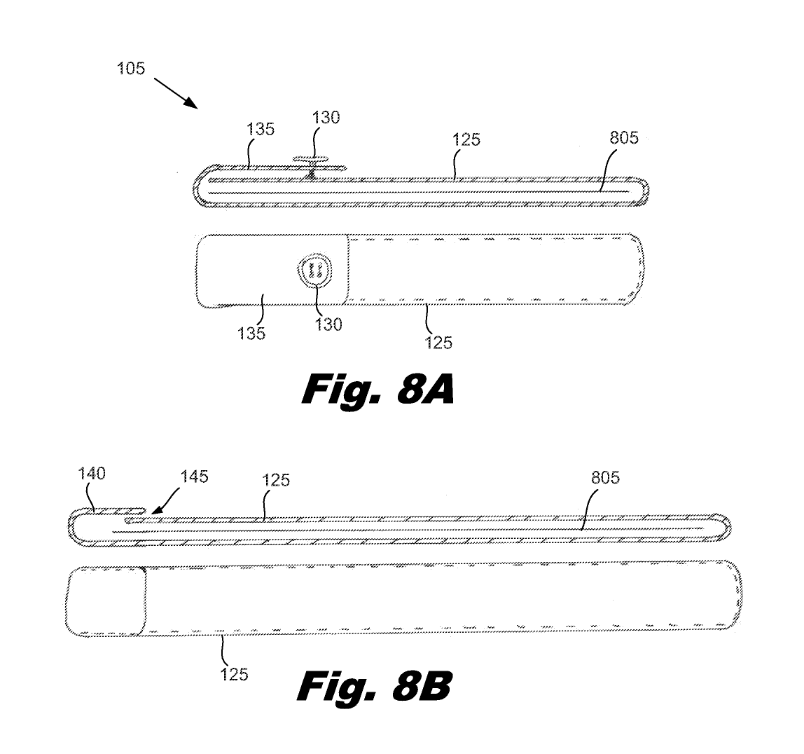

The resilient gripping member may be formed in a variety of ways. In one example, the resilient gripping member is formed by placing a bi-stable spring in a pouch and then connecting the pouch to the textile. FIGS. 8A and 8B show two illustrative examples of the resilient gripping member (105) consisting of a bi-stable spring (805) in a pouch (125). In FIG. 8A, the pouch (125) is formed from a flexible fabric that is sewn or otherwise formed into the desired shape. The pouch (125) has a long pocket that corresponds to the shape of the bistable spring (805) and a flap (135) that is secured over the bi-stable spring (805) to retain it in place. In this example, the flap (135) is secured using a button (130) or a snap. A number of alternative connection methods may also be used. For example, a fabric hook-and-loop fastener, such as VELCRO@ could be used.

FIG. 8B shows an alternative configuration where the pouch (125) includes a flap (140) that is sewn to form a slit (145) through which the bi-stable spring (805) can be inserted. The slit (145) is configured to allow the bi-stable spring to be slipped through the slit (145) and into the interior of the pouch (125) but to prevent the bistable spring (805) from inadvertently exiting the pouch (125) during use.

These pouches can be removable or permanently attached to the textile. For example, the pouches may be sewn or adhered to the textile. In other examples, the pouches may be attached to the textile in such a way that the pouch can be removed. This can be accomplished using a variety of other means, including buttons, snaps, hook-and-loop fabric, or other appropriate method. Because the bistable spring and/or pouch can be removed from the textile, the textile can be separately cleaned if desired.

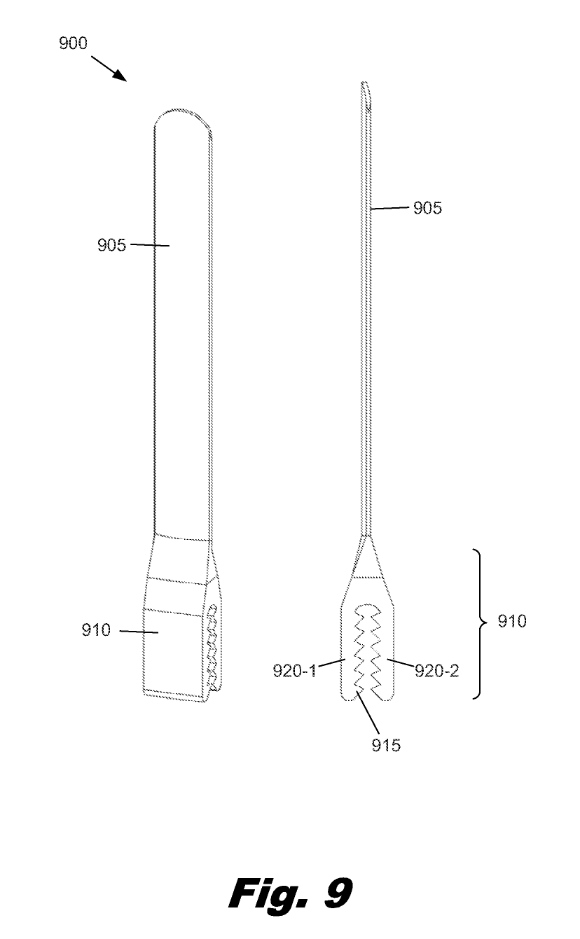

FIG. 9 shows an alternative embodiment of the resilient gripping member. In this embodiment, the resilient gripping member (900) includes a bi-stable spring (905) with a connector (910) at one end. The connector (910) is used to connect the resilient gripping member (905) to the textile. In this example, the connector (910) includes two opposing elastic jaws (920-1, 920-2) that have a number of teeth (915). The connector (910) is connected to the textile by forcing the textile between the elastic jaws (920). This opens the jaws (920) and engages the teeth (915) with the textile. This secures the textile to the resilient gripping member (900). This embodiment allows the resilient gripping member to be separately obtained and to be connected to a wide variety of textiles according to the needs of the user.

If desired, the textile can be removed in a variety of ways. In one example, the textile is removed simply by pulling the textile out of the jaws with sufficient force to spread the jaws apart. The teeth and jaws can be designed to securely grip the textile but to prevent the textile from tearing when the textile is removed. In other examples, the textile may be moved sideways out of the teeth.

A variety of other connection schemes could be used to connect the resilient gripping member to the textile. For example, the connector (910) could include a knob that is forced through a slit in the textile. In other examples, the connector and textile could be snapped or buttoned together. In some embodiments, the resilient gripping member could be connected to the textile using magnetic force.

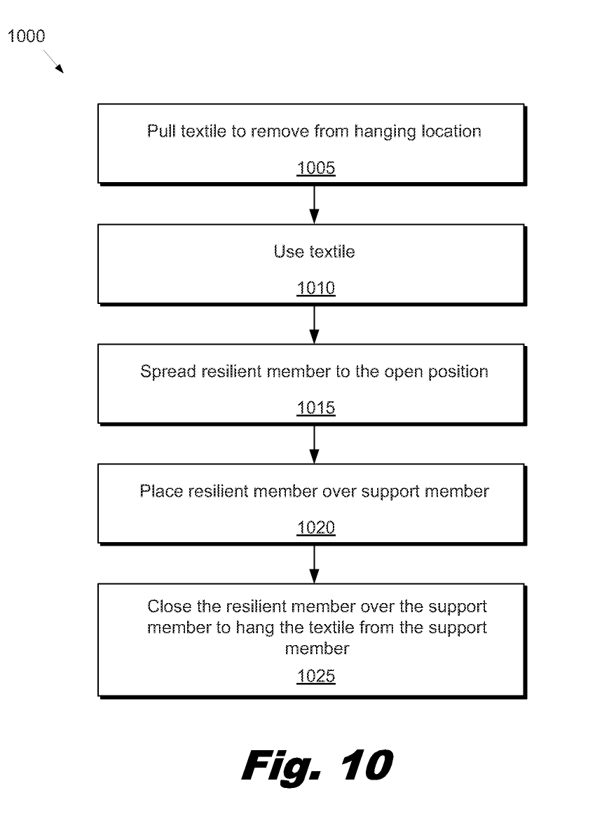

FIG. 10 is a flowchart of an illustrative method for removing and reconnecting a textile from a support member. Initially, the textile is hanging from a support member with the resilient gripping member wrapped around the support member. All that is necessary to remove the textile from the support member is to simply pull on the textile from any of a wide range of angles (step 1005). The resilient gripping member flexes open and releases the resilient gripping member and textile from the support member. This is a significant advantage over techniques that require specific manipulation of the textile to release it.

The textile is then used for its intended purpose (step 1010). After use, the user returns the textile to its support member by spreading the resilient gripping member to an open position. For example, if the anchor member is a bi-stable spring, the user straightens the bi-stable spring to its straight configuration. The user then places the resilient gripping member over the support member (step 1020) and closes it over the elongated member, rod, or appliance handle to hang the textile from the support member (step 1025). As shown above in FIGS. 6 and 7, this may be accomplished in some embodiments by tapping or pushing the resilient gripping member against the support member. This causes the resilient gripping member to curl around the support member.

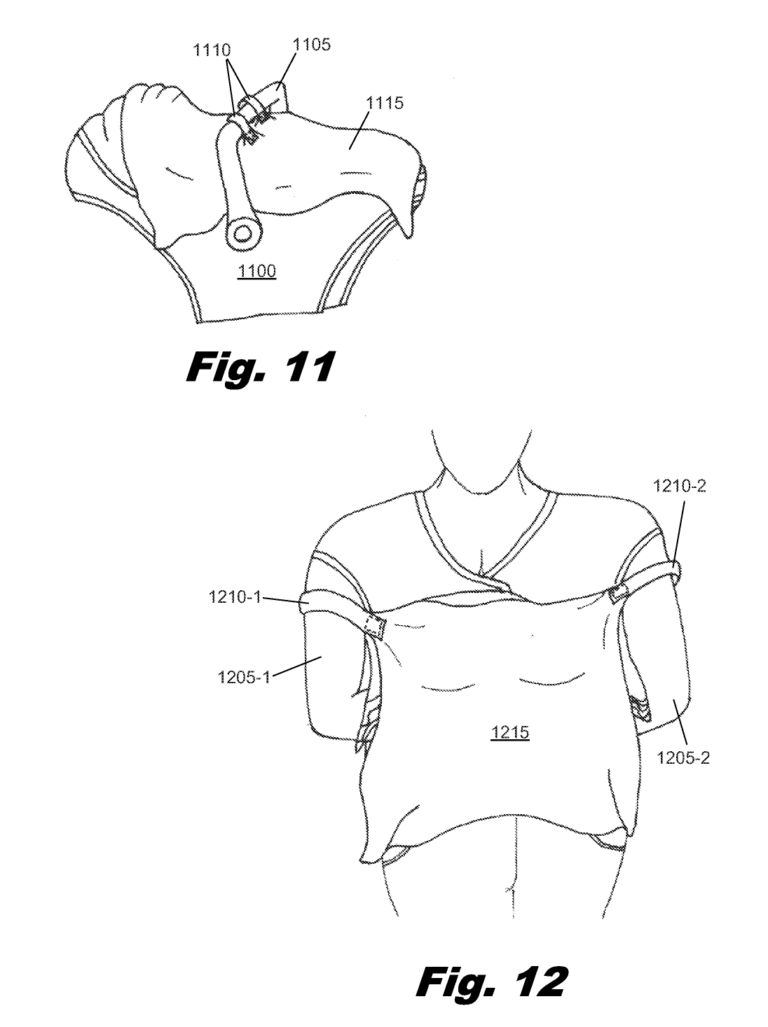

The principles and methods described above could be used to connect the textile assembly to a wide range of objects for a variety of purposes. FIGS. 11, 12, 13A and 13B show several illustrative examples.

FIG. 11 is a diagram of a textile assembly connected to the handle (1105) of a baby carrier (1100) by resilient gripping members (1110). Fabric is often draped over a baby carrier to keep a baby dry, warm, or to protect the baby from sunlight. In many instances, a blanket is simply draped over the entire baby carrier. However, the blanket can easily slide off the baby carrier and securely gripping the handle (1105) that is covered by the blanket can be difficult. FIG. 11 shows a textile assembly that includes two resilient gripping members (1110) that can be removably attached to the handle (1105) of the baby carrier (1100) to secure the textile cover (1115) in place while still allowing direct access to the handle (1105). In some embodiments, the inside surfaces of the resilient gripping members (1110) may include features or texture that increases surface friction with the handle. (1105) and prevents sliding of gripping members along the handle. This type of configuration could be used to secure a textile to wide variety of structures. For example, the textile assembly could also be secured a sun shade or handle of a stroller.

FIG. 12 is a diagram of a textile assembly used as a nursing cover. In this example, the resilient gripping members (1210) are connected to the textile (1215) so that they can be fastened around the mother's arms (1205). This loosely secures the nursing cover so that it remains in place and provides the desired level of privacy.

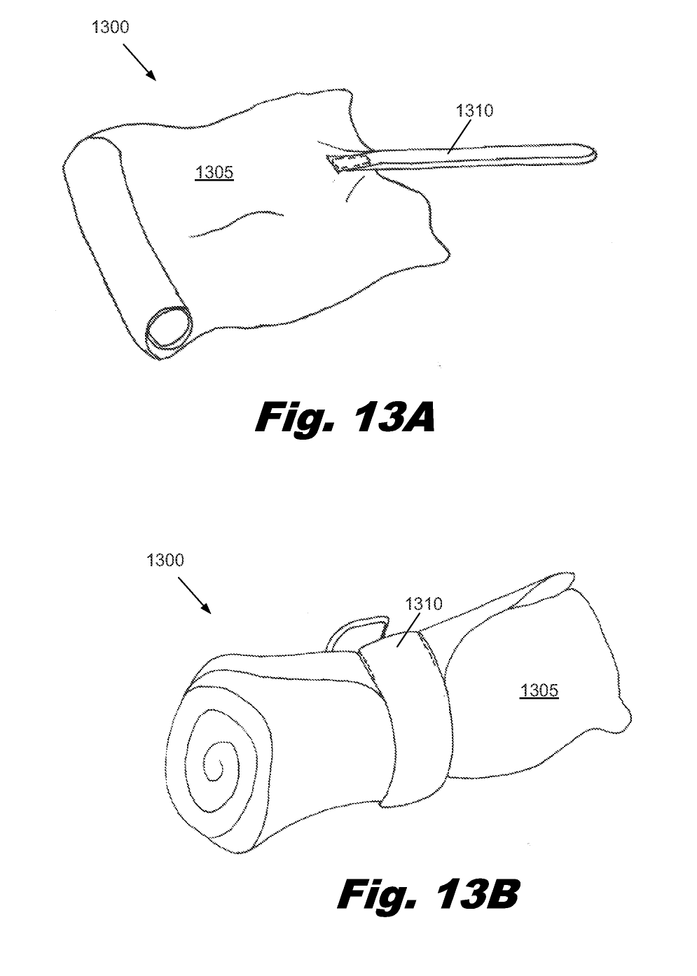

When the textile assembly is no longer in use, the resilient gripping members can secure the textile in a folded position. This provides a convenient and compact method for storing the textile assembly. FIG. 13A shows the resilient gripping member (1310) detached from a support member and in its straight configuration. The textile portion (1305) is then rolled or folded from the bottom toward the resilient gripping member (1310). FIG. 13B shows the resilient gripping member (1310) wrapped around the rolled textile (1305) to secure it in its rolled configuration. This allows the rolled textile assembly to be stored and handled without the textile coming unrolled.

The preceding principles describe methods to secure a variety of textile objects to a support member. A resilient gripping member connects the textile object to the support member and eliminates the need for the user to equally balance the textile on either side of an elongated member, making the textile easier to hang. The characteristics of this device make the textile easier to remove, easier to hang, and easier to store than other devices already in use.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for hanging and retrieving a textile object from a support member comprising:
spreading open a resilient gripping member;
placing the resilient gripping member around the support member such that the textile object hangs from the support member; and
pulling on the textile object to release the textile object from the support member.

2. The method of claim 1, further comprising inserting the resilient gripping member in a pouch attached to the textile object.

3. The method of claim 2, further comprising securing the resilient ripping member in the pouch.

4. The method of claim 1, in which the resilient gripping member is a bistable spring.

5. The method of claim 4, in which the spreading of the resilient gripping member open comprises moving the resilient gripping member to a stable straight position.

6. The method of claim 5, in which placing the resilient gripping member around the support member comprises triggering a transition between the stable straight state and a second curled state by forcing the bistable spring against the support member.

7. The method of claim 1, in which the textile object is configured to be removed by pulling on the textile object in any direction to flex the resilient gripping member and pull the resilient gripping member from the support member.

8. A hanger comprising of a bi-stable ribbon spring having a first stable linear shape and a second stable coiled state, the spring configured to be attached to a textile object and configured to be transitioned between the first stable linear shape and the second stable coiled state by a user induced force against a support member, such that the bi-stable ribbon spring coils around the support member and secures the textile object to the support member.

9. A system for hanging a textile comprising:
a textile;
a bi-stable resilient gripping member connected to the textile, in which the bi-stable resilient gripping member is configured to at least partially encircle a support member.

10. The system of claim 9, further comprising a flexible pouch connected to the textile, in which the resilient gripping member is contained within the pouch.

11. The system of claim 9, in which a first end of the resilient gripping member is removably connected to the textile.

12. The system of claim 11, in which the first end of the resilient gripping member comprises flexible jaws that grip the textile.

13. The system of claim 9, in which the resilient gripping member is configured such that the textile can be detached from the support member by pulling the textile away from the support member in any direction.

14. The system of claim 9, in which the textile comprises fabric and the support member comprises a hook or rod.

15. The system of claim 9, in which the resilient gripping member comprises an elongated elastic bi-stable spring.

16. The system of claim 15, in which the resilient gripping member is a bi-stable metal strip having a first straight state and a second curled state.

17. The system of claim 9, in which the resilient gripping member is a curled polymer strip.

18. The system of claim 9, in which the support member has a closed geometry.

19. The system of claim 9, in which the textile comprises a towel and the bi-stable resilient gripping member comprises an elongated elastic bi-stable spring;
the system further comprising a pouch attached to the towel, the bi-stable resilient gripping member being contained within the pouch and configured to curl around a support member to attach the towel to the support member.

20. The system of claim 9, in which the textile is rolled or folded for storage and the hi-stable resilient gripping member is closed around the textile to secure the textile in its rolled or folded configuration.
